(19) United States
(12) Patent Application Publication
(10) Pub. No.: US 2017/0035082 A1
(43) Pub. Date: Feb. 9, 2017

(54) PASTA PROCESSING FOR LOW PROTEIN FLOUR AND DECREASED DRYING

(71) Applicant: GENERAL MILLS, INC., Minneapolis, MN (US)

(72) Inventors: Nurhan Pinar Tutuncu, St. Paul, MN (US); Jennifer E Folstad, Blaine, MN (US); Kimberly Miller, Brooklyn Park, MN (US); Benjamin Lee Heitke, Corcoran, MN (US); Anthony Beager, Victoria, MN (US)

(73) Assignee: General Mills, Inc., Minneapolis, MN (US)

(21) Appl. No.: 15/101,167

(22) PCT Filed: Dec. 1, 2014
(86) PCT No.: PCT/US14/67966

§ 371 Date: Jun. 2, 2016

Related U.S. Application Data
(63) Continuation-in-part of application No. 14/094,319, filed on Dec. 2, 2013.

(51) Int. Cl. A23L 7/109; A23L 29/212; A23P 30/20

(52) U.S. Cl. CPC A23L 7/109; A23P 30/20; A23L 29/212; A23V 2002/00

(57) ABSTRACT

A pasta product can be formed from a low protein flour by blending the low protein flour with water to form a pasta dough. In some examples, the pasta dough is then hot extruded to produce an extruded pasta before being dried. In contrast to cold extrusion where the goal is to minimize starch gelatinization while shaping the pasta dough, hot extrusion can cause starch within the low protein flour to gelatinize. The gelatinized starch may help compensate for the lack of protein network structure caused by using a low protein flour.

### CROSS-REFERENCE

This application is a continuation-in-part of U.S. patent application Ser. No. 14/094,319, filed Dec. 2, 2013, and PCT Patent Application No. PCT/U.S. patent application Ser. No. 14/64973, filed Nov. 11, 2014. The entire contents of both of these applications are incorporated herein by reference.

### TECHNICAL FIELD

This disclosure relates to food products and, more particularly, to pasta and pasta production techniques.

### BACKGROUND

Commercial manufacture of dried pasta usually involves hydrating flour with water to form a pasta dough and then cold extruding and drying the pasta dough to create a shelf-stable pasta product. Traditionally, high protein flour such as durum semolina and hard red spring wheat are used in the commercial manufacture of pasta products. The high protein levels in these flours form a strong protein network. In particular, during the drying stage of manufacture, the proteins denature to form a protein network. This provides textual firmness that holds the pasta together after drying and also holds the flour starch together during cooking. Without the strong protein network, the pasta can fall apart into its constituent components either before cooking or while cooking. Because lower protein flours such as soft winter wheat do not have enough protein to form a strong protein network, manufacturers have historically not used these types of flours to produce pasta products.

In addition to being limited to ingredients that provide a sufficiently strong pasta structure, manufacturers have also been limited by the amount of time and cost required to dry pasta during production. In general, pasta needs to be dried slowly to avoid checking and breaking during the drying process. For typical pasta dough, drying can take four or more hours to reduce the moisture content down to a level where the pasta is shelf stable. Because of the amount of time and energy required to dry pasta, drying can account for more than half the cost of producing a pasta product.

### SUMMARY

In general, this disclosure is directed to pasta products and techniques for producing pasta products that utilize low protein flour. In some examples, a pasta is formed by blending a low protein flour with water to form a pasta dough. The pasta dough is then hot extruded to produce an extruded pasta before being dried. In contrast to cold extrusion where the goal is to minimize starch gelatinization while shaping the pasta dough, hot extrusion can cause starch within the low protein flour to gelatinize. The starch can form a gelatinized network that provides textual firmness and rigidity to the pasta product. The gelatinized starch network may help compensate for the lack of protein in the low protein flour and, correspondingly, the resulting reduced strength protein network. That is, starch gelatinization in the lower protein dough may replace the protein network that would otherwise be present in a higher protein pasta dough, enabling desired texture characteristics required by consumers and manufacturers. By controlling the constituent components of the pasta dough and the extrusion conditions, the degree of starch gelatinization can also be controlled. In some examples, the pasta dough is partially but not fully gelatinized during extrusion to provide a pasta product having partially gelatinized flour starch. Depending on the application, partial gelatinization may reduce or eliminate product fracturing and/or a rubbery product texture that may otherwise occur if the flour starch is fully gelatinized.

In addition, in some examples, the pasta is formed by blending the low protein flour with an atypically small amount of water to form the pasta dough. For example, traditional pasta manufactures may extrude pasta dough having 28 to 35 weight percent water. Oftentimes, the high water content is necessary to facilitate formation of the protein network structure that ultimately holds the resulting product together. In contrast to these high water loadings, a pasta dough that is extruded to form a pasta product in some examples according to the disclosure can have a moisture content less than 30 weight percent. By utilizing less water in the pasta dough, the resulting pasta product can be dried in less time and less expensively down to the final product moisture than if the pasta dough has a higher moisture content. As a result of this drying advantage, the production techniques may be used to form a pasta product using a comparatively high protein content flour, such as those traditionally used in pasta production, in addition to or in lieu of a low protein flour.

In one example, a method is described that includes blending a flour containing ungelatinized starch and having less than 11 weight percent protein with water to form an extrudable pasta dough having a moisture content less than 30 weight percent. The method also includes extruding the extrudable pasta dough at a temperature greater than 65 degrees Celsius and thereby partially gelatinizing the ungelatinized starch to produce an extruded pasta product, and drying the extruded pasta product.

In another example, a pasta product is described that includes flour having less than 11 weight percent protein and a moisture content less than 15 weight percent. The example specifies that the pasta product has less than 90% starch gelatinization.

In another example, a method is described that includes blending a flour containing ungelatinized starch with liquid water to form an extrudable pasta dough. The liquid water has a temperature greater than 50 degrees Celsius such that blending the flour with the liquid water initiates gelatinization of the ungelatinized starch. The method further includes extruding the extrudable pasta dough at a temperature greater than 50 degrees Celsius and thereby further partially gelatinizing the ungelatinized starch to produce an extruded pasta product. In addition, the method involves drying the extruded pasta product.

In another example, a method is described that includes blending a flour containing ungelatinized starch with liquid water having a temperature ranging from 60 degrees Celsius to 98 degrees Celsius in an absence of steam to form an extrudable pasta dough. The method further includes hot extruding the extrudable pasta dough at a temperature greater than 50 degrees Celsius without exposing the extrudable pasta dough to steam to produce an extruded pasta product and drying the extruded pasta product.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a flow diagram illustrating an example process for forming a pasta product.

FIG. 2 is a block diagram illustrating example components of an extruder system that may be used to process a pasta dough.

FIG. 3 is a plot illustrating example pasta drying data.

### DETAILED DESCRIPTION

In general, this disclosure relates to pasta products and techniques for manufacturing pasta products. The term pasta generally refers to unleavened dough, made of flour, water, and other optional ingredients, that is formed into any of a variety of shapes and dried before being boiled by an end consumer. In some examples, the pasta is manufactured using a low protein flour, such as a flour having less than 11 weight percent protein. The low protein flour and water can be blended together with an amount of water effective to partially but not fully gelatinize the ungelatinized starch in the flour during subsequent processing. After suitably blending and hydrating the flour and any other optional ingredients with water together to form an extrudable pasta dough, the dough is extruded at an elevated temperature to form an extruded pasta product. The ungelatinized starch within the flour can gelatinize during the extrusion process upon being exposed to the elevated temperature. This can form a gelatinized starch network that helps hold the pasta together.

After extruding the pasta dough, the extruded product may be dried to remove excess moisture from the pasta, allowing the pasta to remain shelf-stable and salable for an extended period of time. Oftentimes, the pasta is dried until the product has a final moisture of less than 13 weight percent, such as in the range of 12 weight percent to 8 weight percent. In instances where a reduced amount of water was added to the pasta dough as compared to traditional pasta manufacturing, the pasta can be dried quicker and with less energy as compared to the traditional pasta. For example, in instances where pasta dough is formed with less than a traditional amount of water and higher energy input effective to partially but not fully gelatinize the ungelatinized starch in the flour during subsequent processing, the resulting pasta product can be dried down to a final product moisture more quickly than if the pasta dough was formed with a traditional amount of water and minimal energy input used in traditional pasta production.

Depending on the application, the pasta may be manufactured using hot water to form the extrudable pasta dough. For example, the hot water can be combined with flour and other optional ingredients to form the extrudable pasta dough that is then extruded at elevated temperature to form the extruded pasta product. The water may be sufficiently hot to cause gelatinization of ungelatinized starch within the flour. The intimate (e.g., homogenous) mixing of the hot water and flour can promote a substantially uniform temperature and correspondingly starch gelatinization across the resulting extrudable pasta dough. A dried pasta product formed from an extrudable pasta dough manufactured using hot water can exhibit substantially reduced cook times for an end consumer as compared to a comparable pasta product manufactured without using hot water.

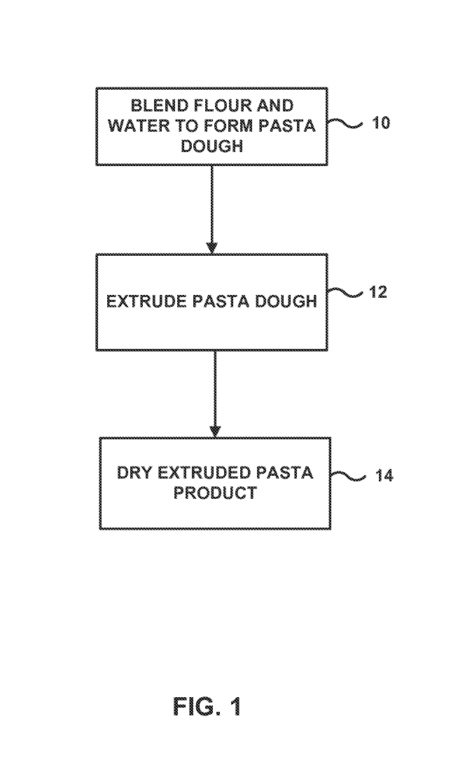

FIG. 1 is a flow diagram illustrating an example process for forming a pasta product. The process includes blending flour and water with optional additional ingredients to form a pasta dough (10) and extruding the pasta dough at an elevated temperature to produce an extruded pasta product (12). After forming the extruded pasta product, the extruded pasta product is dried (14) down to a final product moisture content. As described in greater detail below, a variety of different product ingredients and processing conditions can be used to arrive at a final product utilizing the example process of FIG. 1.

To make a pasta dough that can be extruded to form an extruded pasta product, flour is blended with water and other ingredients. Manipulating the type, quality, and quantity of flour in the pasta dough modifies the resulting pasta product performance. In some examples, the pasta dough is manufactured using a low protein flour. Low protein flour is typically less expensive than higher protein flours and may also be desired by individuals with certain dietary restrictions, such as individuals on a low protein diet. A low protein flour may have less than 15 weight percent protein, such as less than 12 weight percent protein, less than 11 weight percent protein, less than 10 weight percent protein, or less than 8 weight percent protein. For example, the low protein flour may range from 3 weight percent protein to 12 weight percent protein, such as from 5 weight percent protein to 11 weight percent protein, or from 7 weight percent protein to 10 weight percent protein. The protein content of the flour may be measured on a dry weight basis before incorporating the flour into the pasta dough. Further, the protein content of the flour may be based on the total weight of all proteins in the flour, where the proteins are generally considered to include any complex organic macromolecule that is composed of one or more chains of amino acids.

Example types of low protein flour that may be used to make a pasta dough include, but are not limited to, soft wheat flour, rice flour, and corn flour. In different examples, the flour can be derived from sources that include grains such as wheat (e.g., soft wheat flour cookie flour), rye, rice, barley, oat, corn, legumes (e.g., beans, peas, lentils), ancient grains like quinoa, sorghum, vegetables, and nuts. Depending on the desired characteristics of the pasta dough and resulting pasta product, the pasta dough can be formed using a single flour or a combination (e.g., mixture) of multiple flours. Where multiple flours are used to form the pasta dough but a low protein flour pasta dough is still desired, the combination of flours may have a combined protein content falling within any of the ranges noted above as being suitable for a low protein flour. For example, a flour mixture suitable for use may contain both high protein flour (e.g., a protein content greater than 11 weight percent) and low protein flour (e.g., a protein content less than 11 weight percent) but still be considered low protein if the total protein content of the flour mixture is within a certain range (e.g., less than 11 weight percent). An example of such a flour may be an all-purpose flour containing both soft wheat and hard wheat, where the relative amounts of hard wheat and soft wheat are sufficient to provide a low overall protein level. While mixtures of high protein and low protein flours can be used, in other examples, the pasta dough is formed using only low protein flour. For example, the pasta dough may be formed using a flour that consists of or consists essentially of low protein flour, such as low protein flour falling within any of the ranges noted above. In one example, the flour used to form the pasta dough consist of or consists essentially of soft winter wheat, which typically has a protein content of approximately 8 weight percent.

Although a pasta product formed from low protein flour may be useful since low protein flour can have cost and dietary advantages, in other examples, a pasta product in accordance with the disclosure is formed using a flour that does not have a low protein level. As described below, the pasta dough may have a lower moisture level than traditional pasta dough, allowing a resultant extruded pasta product to be dried more efficiently than traditional pasta products. Additionally or alternatively, the resultant pasta product may cook faster than pasta products produced using traditional methods. These benefits may be useful to produce pasta products using non-low protein flours as well as low protein flour. Accordingly, in some examples, the pasta dough can be formed by blending water with any desired flour or combination of flours. Example flours can include durum wheat derived semolina flour, rice flour, buckwheat flour, hard wheat flour, soft wheat flour, pasta regrind from wheat based pastas, farina flour, corn flour, bean flour (e.g., black bean, garbanzo bean), lentil flour (e.g., red lentil), pea flour (e.g., yellow pea), and combinations thereof. In some examples, the flour used to form the pasta dough includes gluten. Gluten is a protein complex that can be found in the Triticeae tribe of grains, which includes wheat, barley and rye. The gluten content in wheat flour may provide organoleptic properties, such as texture and taste, to the pasta products. In other examples, the flour used to form the pasta dough is substantially or entirely free of gluten such that the dried pasta product can be labeled as gluten free.

Independent of the specific type or types of flours used to form the pasta dough, the flour will typically include starch. In general, starch is a polymer formed of linked anhydro-a-D-glucose units. It may have either a mainly linear structure (amylose) or a branched structure (amylopectin). The molecular weight of the constituent polymers, particularly amylose, varies between different starch sources. In native, uncooked and ungelatinized form, the starch molecules amylose and amylopectin are located within starch granules that are insoluble in cold water. Flour, independent of the source and protein content, typically includes ungelatinized starch, such as uncooked, ungelatinized starch. The ungelatinized starch may have a semi-crystalline structure. By contrast, when the starch is cooked to provide cooked, pregelatinized starch, the starch granules can swell, burst, and lose their semi-crystalline structure.

The flour (e.g., wheat flour) used in the pasta dough may have any suitable amount of ungelatinized starch. Typically, the amount of ungelatinized starch in the flour will vary from 60 to 75 weight percent depending on the type of flour, the growing conditions, and the processing performed on the flour prior to incorporation into the pasta dough. In some examples, the flour (e.g., wheat flour) used to form the pasta dough has at least 70 weight percent ungelatinized starch. For example, a low protein flour may have from 71 weight percent to 74 weight percent ungelatinized starch. The amount of ungelatinized starch in the flour may be measured on a dry weight basis before incorporating the flour into the pasta dough.

In other examples, such as examples where other types of flours that are not wheat flour are used for the pasta product, the flour may be pre-treated and/or pre-gelatinized prior to hydration and formation of the pasta dough. For example, in instances in which bean flour, legume flour, corn flour, and/or rice flour is used, the flour may be pre-treated and/or partially or fully gelatinized prior to forming the pasta dough.

To form the pasta dough, the flour or combination of flours are blended together with water. The amount of water added to the flour can vary, e.g., depending on the type of flour used in the dough, the extrusion performance of the dough, and desired properties of the resultant product. Further, the water added to the flour can either be added by itself (e.g., as tap water, distilled water) or as part of a water-containing liquid (e.g., milk, broth). In some examples, an amount of water is added to the flour that is effective to partially but not fully gelatinize the ungelatinized starch contained in the flour during subsequent processing. During subsequent processing, the pasta dough can be heated during extrusion to a temperature that causes the ungelatinized starch in the dough to gelatinize. The degree of gelatinization may be controlled, for example, by controlling the amount of water available within the pasta dough for reacting with the ungelatinized starch. In addition to or in lieu of controlling the amount of water added to the flour to control the degree of starch gelatinization, the amount of water may be controlled to limit drying requirements after extrusion. In general, the more water that is added to the flour before extrusion, the greater the amount of drying that is required after extrusion.

In some examples, an amount of water is added to the flour that is effective to provide the pasta dough with a moisture content less than 40 weight percent, such as less than 30 weight percent, less than 25 weight percent, or less than 20 weight percent. For example, the amount of water added to the flour may be effective to provide the pasta dough with a moisture content ranging from 8 weight percent to 30 weight percent, such as from 12 weight percent to 25 weight percent, or from 10 weight percent to 20 weight percent. The amount of moisture in the pasta dough may be measured based on the total weight of the pasta dough, including any optical additives, and may account for all sources of moisture in the dough (e.g., both added moisture and moisture present in the constituent components of the dough before combination).

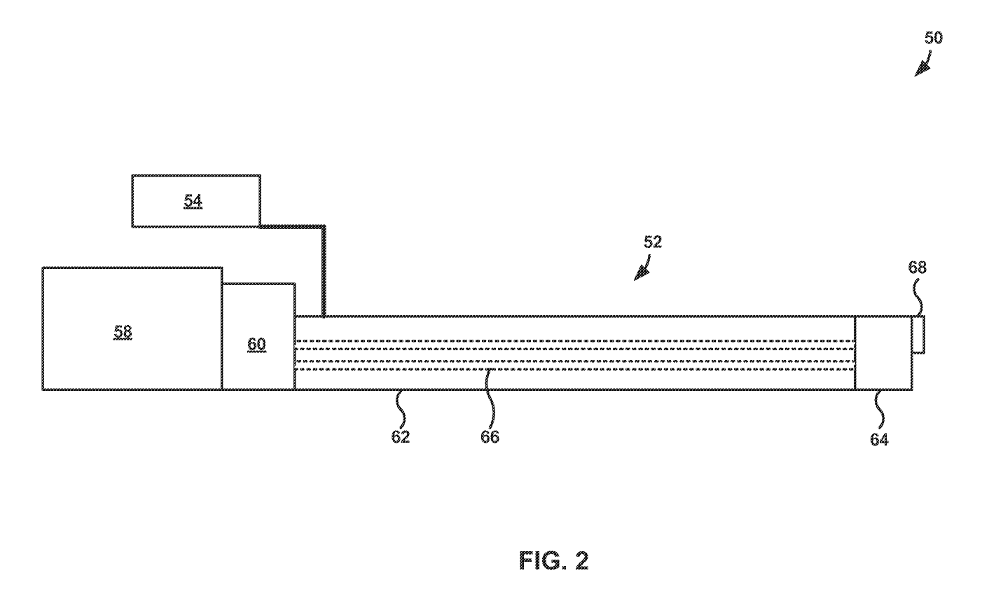

The water added to the flour to form the pasta dough can be added in liquid form, vapor form (e.g., steam), or both liquid and vapor form. When steam is added to the flour, the steam can be injected into an extruder to which the flour is added, such as any variety of extruder described below with respect to FIG. 2. In some applications, the liquid water source and/or steam can be homogenously blended or mixed with the flour and other optional ingredients prior to or concurrent with being feed to the extruder. For example, liquid water and/or steam can be combined with the flour and other optional ingredients in a mixer to form a dough that is then fed into the extruder.

Independent of whether the liquid water and/or steam is combined with the flour and other optional ingredients prior to being introduced into the extruder or inside of the extruder, the water can mix with the flour and other ingredients to form a dough. For example, the water and flour may be mixed an amount effective to fully hydrate the flour to form a dough. When so mixed, there dough may be substantially or entirely devoid of residual dry flour. The viscosity of the dough may vary, e.g., depending on the amount of water added to the flour, the composition of the flour used to form the dough, and the type of optional ingredients (if any) added to the dough.

By controlling the temperature of the water added to the flour and other optional ingredients during the dough formation process, the cook properties of a pasta product produced from the dough may be controlled. For example, adding hot water to the flour during manufacture of the extrudable dough may be useful to adjust the cook time of the resultant pasta product. Using hot water in the dough formation process can produce a dried pasta product that cooks faster than a corresponding dried pasta product formed using cold water during dough formation (but is otherwise identically processed).

Without wishing to be bound by any particular theory, it is believed that the addition of hot water to flour during dough formation initiates gelatinization of uncooked, ungelatinized starch within the flour. The temperature of the flour can increase upon addition of the hot water to the flour such that the resulting dough has a temperature greater than the temperature of the flour. The elevated temperature of the dough can cause the starch within the pasta dough to begin to gelatinize. During gelatinization, starch can hydrate and swell, causing the crystalline structure of the starch to be destroyed. Through this process, the starch may release amylose and amylopectin molecules and form an aqueous starch network. The formation of the aqueous starch network can bind the pasta product together. Further, the breakdown of the starch during the gelatinization process can reduce the amount of time the resulting pasta product needs to subsequently cook in boiling water to be properly cooked for consumption.

The process of cooking pasta in boiling water typically causes at least two chemical changes to the structure of the pasta: protein within the pasta absorbs water and swells, and starch within the pasta gelatinizes and begins breaking down. By using hot water during the dough formation process, the protein within the flour can begin absorbing water and/or the starch within the flour can begin gelatinizing. As a result, the amount of time needed to subsequently cook the pasta to a point where the proteins within the pasta are sufficiently swelled and/or the starches sufficiently gelatinized for consumption may be reduced as compared to when a colder temperature water is used during dough formation.

Depending on the application, hot extrusion of the pasta dough can work synergistically with effects of the hot water used to form the dough to reduce cook time of the pasta product. The addition of hot water to flour to form dough can initiate gelatinization of uncooked, ungelatinized starch within the flour and/or initiate swelling of proteins within the flour. By hot extruding the dough, the temperature of the dough can be controlled to allow the starch gelatinization/protein swelling process initiated upon addition of the hot water to further progress. For example, when partially but not fully gelatinizing the uncooked, ungelatinized starch in the flour used to produce the pasta product, the addition of hot water to the flour can initiate gelatinization of the ungelatinized starch. Hot extrusion of the extrudable dough (e.g., such that the extruder is heated at least above ambient temperature during extrusion) can further partially gelatinize the ungelatinized starch, the gelatinization of which was initiated upon addition of the hot water.

When hot water is used to form an extrudable dough, the water is generally at a temperature sufficient to cause gelatinization of at least some of the uncooked, ungelatinized starch within the flour with which the water is combined. In different examples, the water combined with the flour is at a temperature above 50 degrees Celsius, such as a temperature above 65 degrees Celsius, a temperature greater than 80 degrees Celsius, or a temperature greater than 90 degrees Celsius. For example, the temperature of the water combined with the flour may range from approximately 55 degrees Celsius to approximately 100 degrees Celsius, such as from 60 degrees Celsius to 98 degrees Celsius, or from 60 degrees Celsius to 95 degrees Celsius, or from 70 degrees Celsius to 95 degrees Celsius.

The flour with which the water is combined will typically be at ambient temperature (e.g., approximately 20 degrees Celsius). Accordingly, in some examples, the temperature of the water combined with the flour may be effective to yield a dough having a temperature above the temperature at which starch within the dough begins gelatinizing. In various examples, the temperature of the water combined with the flour may be effective to yield a dough having a temperature greater than 55 degrees Celsius, such as a temperature ranging from 60 degrees Celsius to 90 degrees Celsius, or from 70 degrees Celsius to 85 degrees Celsius.

Although steam can be used in addition to or in lieu of liquid water, it has been found in some examples in practice that the addition of steam to flour during dough formation causes the resulting pasta product to take on a rigid/rubbery texture. As a result, a pasta product formed from a dough manufactured by combining flour with steam can take longer to cook than a pasta product formed from a dough manufactured by combining flour with hot water alone. Accordingly, in some applications, the pasta dough is formed by combining flour and other optional ingredients with hot liquid water but without steam (in the absence of steam). In other words, all water added to the flour and other optional ingredients to form the extrudable dough and/or introduced into the extruder may be in liquid form such that the flour and other optional ingredients are not exposed to steam prior to or during extrusion. The hot liquid hot water can be at any of the foregoing temperatures or ranges discussed above. In addition, hot extrusion of the extrudable pasta dough can occur in the absence of steam, e.g., such that extruder is externally heated without injecting steam into the extrudable dough. Foregoing the use of steam can help minimize the amount of time needed to cook the resulting pasta product.

Independent of controlling cook time of the pasta product, adding hot water and/or steam to the flour during manufacture may be useful to adjust the texture of the resultant pasta product. For example, using hot water and/or steam may yield a pasta product that is harder than a comparable product produced using cold water. In some examples, the water added to the flour is at a temperature above 50 degrees Celsius, such as a temperature above 65 degrees Celsius, or a temperature greater than 80 degrees Celsius.

Although steam and/or high temperature water can be added to the flour to form the pasta dough, in other examples, a comparatively cold water is added to the flour to form the pasta dough. For example, the water added to the flour may be at a temperature below 35 degrees Celsius, such as a temperature below 25 degrees Celsius, or a temperature below 15 degrees Celsius. The use of comparatively cold water may help prevent premature starch gelatinization and/or help prevent starch from washing out of the flour before gelatinization, which may otherwise occur when using comparatively higher temperature water. That being said, a pasta can be formed using any suitable temperature water, and the disclosure is not limited in this respect.

In addition to incorporating flour and water, the pasta dough may contain additional optional ingredients. When additional ingredients are used, the ingredients may be added to the pasta dough at any time during the production process, e.g., before extrusion of the pasta dough. Controlling the type, quality, and quantity of ingredients added to the pasta can control the taste, texture, and performance of the pasta, both during processing and during subsequent cooking and consumption. Example ingredients that may be added to the pasta dough include, but are not limited to, starches and protein sources. Starches from sources such as rice, corn, potato and the like also can be added, e.g., in amounts from 0.25 weight percent to about 20 weight percent, such as less than 15 weight percent, based on the total weight of the pasta dough. Typical protein sources that may be added to the pasta dough include wheat gluten, milk protein, soy protein and eggs in any form including whole eggs, egg whites, powdered eggs, powdered egg whites and the like. When used, the protein source may be added in amounts from 0.25 weight percent to 20 weigh percent, such as less than 15 weight percent or from 0.5 weight percent to 10 weight percent, based on the total weight of the pasta dough.

A variety of natural and artificial flavors, herbs, spices, cheeses and the like also can be added to the pasta dough, if desired. In one application, salt is added to the pasta dough, for example up to 3 weight percent. The added salt may improve hydration by creating voids within the structure of the pasta after the salt dissolves during cooking. Highly soluble salts can dissolve during cooking, leaving fine trails or voids in the pasta structure that facilitates water penetration during cooking. In addition to or in lieu of salt, additional seasonings, spices, and/or flavorings such as meat or vegetable flavors may be added to the pasta dough, e.g., in amounts of from 0.1 weight percent to 3 weight percent by weight based on the total weight of the pasta dough.

Although the pasta dough can include a variety of added ingredients besides flour and water, the pasta dough may be substantially free or entirely free of some ingredients, such as ingredients that change the performance of the dough during processing and/or the final pasta product. For example, the pasta dough may be substantially or entirely free of added starch and/or added protein and/or added gluten. In such examples, substantially any or any starch (e.g., uncooked, ungelatinized starch) and/or protein and/or gluten in the pasta dough may be from the flour added to the pasta dough rather than an additional ingredient.

Depending on the amount of additional ingredients added to the pasta dough, the flour and water components of the dough may be greater than 75 weight percent of the dough, such as greater than 85 weight percent of the dough, greater than 95 weight percent of the dough, or greater than 98 weight percent of the dough. In one example, the flour and water components of the dough are approximately 100 weight percent of the dough.

After selecting a desired combination of ingredients for the pasta dough, the ingredients can be combined together and processed to form the dough. In general, any suitable processes may be used to blend the ingredients together to form the dough. In some examples, the ingredients (or a subset thereof) are mixed together and then introduced into an extruder. In other examples, the ingredients are separately introduced into an extruder, for example sequentially through a feed inlet or simultaneously through separate feed inlets. In either case, the ingredients may blend together within the extruder, e.g., to form a compositionally homogenous pasta dough.

FIG. 2 is a functional block diagram illustrating example components of an extruder system 50 that may be used to process the constituent ingredients of the pasta dough to form an extruded pasta product. In the example of FIG. 2, extruder system 50 includes an extruder 52 and a material delivery apparatus 54. During operation, material delivery apparatus 54, which may comprise one or multiple delivery apparatuses, delivers flour, water, and any optional ingredients to the extruder 52. Extruder 52 may receive dry and liquid ingredients, mix the ingredients together to form a dough, and extrude the dough through a die into a three dimensional shape. As noted above, in other examples, all the constituent ingredients of the pasta dough can be mixed in a batch or continuous mixer to form a dough that is then fed into extruder 52. Other ingredient delivery configurations are possible.

Extruder 52 can have a variety of different mechanical configurations. In the example of FIG. 2, however, extruder 52 includes a motor 58, a gear box 60, an extruder barrel 62, an extruder die 64, and a cutter 68. Extruder barrel 62, which may be formed of multiple barrel sections, contains at least one screw (e.g., single screw extruder) which, in the illustrated example, is shown as two screws 66 (e.g., twin screw extruder). During use, motor 58 rotationally drives screws 66 to generate a forwardly directed motion in the direction of extruder die 64. Screws 66 may mix, convey, and pressurize the constituent ingredients of the pasta dough as motor 58 rotates the screws and conveys the formed dough toward the die, which provide an opening area restriction responsible for the pressure build-up. Extruder die 64 receives the pressurized and mixed ingredients forming the pasta dough and shapes the ingredients as the ingredients pass through a discharge aperture in the die, thereby forming an extruded pasta product. Cutter 68 is located downstream from extruder die 64 and can cut the extrudate into discrete pieces of specific size (e.g., specific length).

In different examples, extruder 52 may be implemented as a single screw extruder or twin-screw extruder. When extruder 52 is implemented as a twin screw extruder that includes two screws 66, the two screws can be positioned tangentially to one another, non-intermeshing, or intermeshing (e.g., overlapping). Further, the two screws can be operated so the screws co-rotate (i.e., so each screw rotates in the same direction) or counter-rotate (i.e., so each screw rotates in a direction opposite from the other screw).

While the dimensions of extruder 52 can vary, e.g., based on the configuration of the extruder and the desired throughput, in some examples, the extruder utilizes one or more screws having an outside-to-inside screw diameter ratio (Dₒ/D_{I}) ranging from 1.5 to 2.2. Additionally or alternatively, extruder 52 may utilize one or more screws having a screw length-to-diameter ratio (L/D) ranging from 8 to 25. Other dimensions are possible.

The specific operating parameters of extruder system 50 can vary, e.g., depending on the hardware configuration of extruder 52, the specific composition of the constituent ingredients of the pasta dough, and the desired properties of the finished pasta product. In general, extruder 52 may be operated at a temperature and pressure that provide thorough intermixing between the ingredients introduced into the extruder and which also elevates the temperature of the ingredients to a temperature above ambient temperature. In some examples, the pasta dough is extruded at ambient or positive pressure without vacuum.

In one example, the extruded pasta product is formed by introducing the constituent ingredients of the pasta dough into extruder 52 and hot extruding the components into the desired shape of the pasta product. As briefly discussed above, the pasta dough typically includes ungelatinized starch. During manufacture in which the pasta dough is hot extruded, the elevated temperature can cause the starch within the pasta dough to gelatinize. As the starch breaks down during this gelatinization process, the starch may release amylose and amylopectin molecules and form an aqueous starch network that can bind the pasta product together. In applications where a low protein flour is used to form the pasta dough, the gelatinized starch network created during hot extrusion may provide a bonding structure that helps compensate for the lack of protein structure caused by the low protein flour.

When pasta dough is hot extruded, the dough may be heated to a temperature sufficient to cause ingredients in the pasta dough to change their chemical structure. For example, the pasta dough may be heated to a temperature sufficient to cause the ungelatinized starch in the pasta dough to gelatinize. This may also cause protein in the pasta dough to denature and form a protein network. The gelatinized starch network and/or protein network may provide structure that holds the resulting pasta product together during further processing and consumption. Accordingly, in some examples, the extruded pasta product is formed by extruding the pasta dough at an elevated temperature that causes ungelatinized starch to at least partially, and in some examples fully, gelatinize. The temperature within extruder 52 may be controlled, for example, by injecting steam into the pasta dough within extruder and/or externally heating extruder barrel 62, e.g., by passing a heat transfer fluids such as steam or heated fluids through a jacket of the extruder barrel. When steam is injected into extruder 52 to hydrate the flour, the steam also heats the flour.

While the specific temperature at which the pasta dough is extruded may vary, in some applications, the dough is extruded at a temperature greater than 50 degrees Celsius, such as a temperature greater than 60 degrees Celsius, a temperature greater than 70 degrees Celsius, or a temperature greater than 80 degrees Celsius. For example, the pasta dough may be extruded at a temperature ranging from 50 degrees Celsius to 100 degrees Celsius, such as from 65 degrees Celsius to 95 degrees Celsius, from 80 degrees Celsius to 100 degrees Celsius, or from 85 degrees Celsius to 95 degrees Celsius. The temperature of the extruder can be controlled so that the dough exiting the extruder is at any of these foregoing temperatures. In addition, in applications were the use of steam is desired to be avoided during the production of the extruded pasta product, the extruder may operate at a temperature below which steam will generate in the extrudable pasta dough during extrusion (for example, as could occur from vaporization of water in the dough). Such a temperature can provide an upper limit to any of the foregoing extrusion temperatures mentioned above.

As discussed above, hot liquid water can be used to form an extrudable dough that is then hot extruded to produce a pasta product exhibiting reduced cook times. In such applications, dough within the extruder may be indirectly heated, e.g., by passing a heat transfer fluid (e.g., liquid water, steam) through a jacket surrounding an extruder barrel. Such a technique can avoid introducing steam into the extrudable dough, which can increase the cook time of the resulting pasta product formed from the dough.

In some examples, the temperature of the extruder may be controlled relative to the temperature of the hot water added to the flour to form the extrudable dough. For example, the extruder may be heated to temperature sufficient to provide a ratio of the temperature of the extruder divided by the temperature of the hot water used to form the extrudable dough ranging from 0.5 to 1.5, such as from 0.7 to 1.3, or from 0.9 to 1.1. For example, the extrusion temperature may range from plus 15 degrees Celsius to minus 15 degrees Celsius of the temperature of the hot water added to the flour to form the extrudable dough, such as from plus 10 degrees Celsius to minus 10 degrees Celsius.

In different examples, the temperature of the extruder can be controlled so the extrusion temperature is greater than the temperature of the hot water added to the flour to form the extrudable dough, less than the temperature of the hot water added to the flour to form the extrudable dough, or approximately equal to the temperature of the hot water added to the flour to form the extrudable dough. In some examples, the temperature of the extruder may be controlled to maintain the temperature of the dough (e.g., so the dough does not meaningfully cool during extrusion) or even further heat the dough beyond the temperature reached upon addition and mixing of the hot water with the flour.

The elevated temperature within extruder 52 can cause the uncooked, ungelatinized flour starch in the pasta dough to cook and gelatinize. The degree of gelatinization may vary based on, e.g., the ingredients used to form the pasta dough, the temperature of the extruder, and residence time of the pasta dough and/or extruded product at the elevated temperatures. In some examples, the pasta dough is extruded at an elevated temperature so the ungelatinized starch in the extruded pasta product is fully gelatinized. In other examples, the pasta dough is extruded at an elevated temperature so the ungelatinized starch in the pasta dough is not fully gelatinized but instead only partially gelatinized. Partial gelatinization may reduce or eliminate product fracturing and/or a rubbery product texture that may otherwise occur if the starch is fully gelatinized.

In examples where the starch in the extruded pasta product is only partially gelatinized, the starch may be gelatinized to an extent sufficient to provide textual firmness that holds the pasta together after drying and also holds the flour starch together during cooking but that does not cause the pasta to fracture and/or have a rubbery texture. In some examples, the pasta dough is extruded to produce a pasta product that has less than 90% starch gelatinization, such as less than 80 percent starch gelatinization. The pasta product in these examples may exhibit at least some starch gelatinization, such as at least 25 percent starch gelatinization, at least 35 percent starch gelatinization, or even at least 50 percent starch gelatinization. In various examples, the pasta product may have from 10 percent starch gelatinization to 90 percent starch gelatinization, such as from 30 percent starch gelatinization to 80 percent starch gelatinization.

In general, the pasta dough can be formed into any suitable shape on extruder 52. The pasta dough can be extruded into any short shape or long shape and may be of conventional or thin wall thickness. In general, thin wall thickness pastas provide faster cooking times for the end consumer than comparatively thicker wall pastas. Depending on the application, a thin wall thickness pasta may have a wall thickness from 0.018 inches to 0.028 inches, such as from 0.018 inches to 0.022 inches, or from 0.024 inches to 0.028 inches. Example pasta shapes that may be formed include bowtie, spaghetti, ziti, rigatoni, linguine, fettuccine, macaroni, lasagna, penne, tagliatella, and manicotti.

After the ingredients introduced into extruder 52 are extruded so as to form an extruded pasta product, the extruded pasta product may be dried to reduce the amount of processing moisture remaining in the product. If the extruded pasta product contains excess processing moisture, the pasta product may not be shelf stable and, as a result, can become oxidized, stale, or moldy, and have a reduced shelf life as compared to when the product contains comparatively less processing moisture. For these and other reasons, the extruded pasta product formed by extruder 52 may be dried after extrusion.

Any suitable techniques can be used to dry the extruded pasta product formed by extruder 52. Example techniques include forced air, belt drying, and fluidized bed drying techniques. In some examples, the extruded pasta product is dried at a temperature less than 150 degrees Celsius, such as a temperature less than 100 degrees Celsius, a temperature less than 75 degrees Celsius, or a temperature less than 50 degrees Celsius. Drying the extruded pasta slowly at a comparatively lower temperature may help avoid checking problems that can occur if the pasta is dried faster at a higher temperature.

In some examples, the extruded pasta product produced by extruder 52 is dried so that the final (dried) extruded pasta product contains less than 15 weight percent moisture (e.g., water), such as less than 12 weight percent moisture, or less than 10 weight percent moisture. For example, the extruded pasta product may be dried until the product contains from 5 weight percent moisture to 15 weight percent moisture, such as from 8 weight percent moisture to 12 weight percent moisture. The extruded pasta product may contain from 10 weight percent to 30 weight percent moisture before drying, such as from 15 weight percent to 25 weight percent moisture.

Depending, for example, on composition of the pasta dough extruded on extruder 52, the extruded pasta product may be dried to a final product moisture comparatively rapidly while avoiding checking problems. For instance, in some examples, the extruded pasta product may be dried at a temperature of less than 85 degrees Celsius for a period of less 5 hours (e.g., less than 3 hours, less than 2.5 hours, less than 2 hours) down to a final product moisture of less than 12 weight percent. The extruded pasta product may contain from 10 weight percent to 30 weight percent moisture before drying, such as from 15 weight percent to 25 weight percent moisture. It should be appreciated that the disclosure is not limited in this respect, and other drying times, temperatures, and moisture contents can be used.

A dried pasta product produced in accordance with the disclosure may be used as a standalone product or may be incorporated into a meal kit that includes other food items that can be cooked with the pasta. The pasta product may also be used in refrigerated, frozen, or thermally processed products. The pasta product may be prepared by immersing the product in hot or boiling water. In other applications, the product may be pre-cooked so the product can be rehydrated, e.g., by pouring hot or boiling water over the product, to facilitate quick preparation, such as microwave cooking. The product may have a textual firmness when cooked ranging from soft or al dente to hard or rubbery. In one example, the product has an al dente textural firmness when cooked.

A pasta product produced in accordance with the disclosure may cook quicker than a comparable product produced using a traditional pasta manufacturing technique. For example, the pasta product may cook in boiling water from a frozen state to al dente in less than 3 minutes. As another example when the pasta product is dried, the pasta product may cook to al dente in less than 7 minutes in boiling water. For example, a dried pasta product (e.g., having less than 12 weight percent moisture) may cook to al dente in a period of time ranging from 4 minutes to 6 minutes after addition to the boiling water, such as from 4.5 minutes to 5.5 minutes. Cooking times may vary, however, based on the size and shape of the pasta product.

The following examples may provide additional details about pasta processing and a pasta product formed in accordance with this disclosure.

### EXAMPLE

### Example 1

### Texture

A low protein pasta dough was formed having approximately 79 weight percent soft winter wheat flour and approximately 21 water. The paste dough was extruded using a Buhler 44 (twin screw extruder) with 7 barrels. The last two barrels of the extruder (6 and 7) were heated to 82 degrees Celsius (180 degrees Fahrenheit). A K-tron feeder was used to feed the soft winter wheat flour into the feed section into the extruder and water was also injected at this point. The material was mixed in the extruder for about 3 minutes. The pasta dough was extruded through two annular-shaped die inserts and face cut. The resulting extruded pasta product was dried down to a final moisture content of 8 weight percent.

For comparison purposes, two high protein pasta dough samples were prepared using a semolina flour and a hard red spring wheat flour. The first comparison sample was composed of approximately 70 weight percent semolina flour and approximately 30 weight percent water. The second sample was composed of approximately 70 weight percent hard red spring wheat flour and approximately 30 weight percent water. The comparison samples were extruded and dried using the same equipment and processing parameters as for the soft winter wheat flour. However, all extruder barrels were cooled with 2 degrees Celsius cooling water for the comparison samples.

The samples were analyzed using a TA.XT Plus texture analyzer. Samples were tested using the TA-93WST Wire Mesh Extrusion Fixture. The plunger was calibrated to a height of 140 mm above the wire mesh at the bottom of the cylinder fixture. A Return to Start test sequence in compression mode was utilized with a button trigger at a distance of 135 mm and a test speed of 5 mm/s to measure the force needed to extrude 75 grams of the cooked pasta sample through the wire mesh. The results are as follows.

| | Average Texture | |
|---|---|---|
| | of Product After | Average Texture |
| | Extrusion, | of Product After |
| | Before Drying | Drying |
| | (Kilogram) | (Kilogram) |
| Soft Winter Wheat | 43.8 | 19.6 |
| Flour Product | | |
| Semolina Flour Product | 13.6 | 15.3 |
| Hard Red Spring | 17.8 | 19.6 |
| Wheat Flour Product | | |

### Example 2

### Drying

Three different pasta samples were prepared to evaluate drying efficiency during pasta production. A first sample was prepared by extruding a pasta dough composed of approximately 30 weight percent water and approximately 70 weight percent semolina flour. A second sample was prepared by extruding a pasta dough composed of approximately 30 weight percent water and approximately 70 weight percent hard red spring wheat flour. A third sample was prepared by extruding a pasta dough composed of approximately 20 weight percent water and approximately 80 weight percent soft winter wheat flour. The samples were extruded using the same extruder configuration and same extrusion conditions. The extruded pasta samples were dried in a controlled humidity dryer at 70 degrees Celsius for the first two hours and 80 degrees Celsius thereafter. The relative humidity was set at 80%.

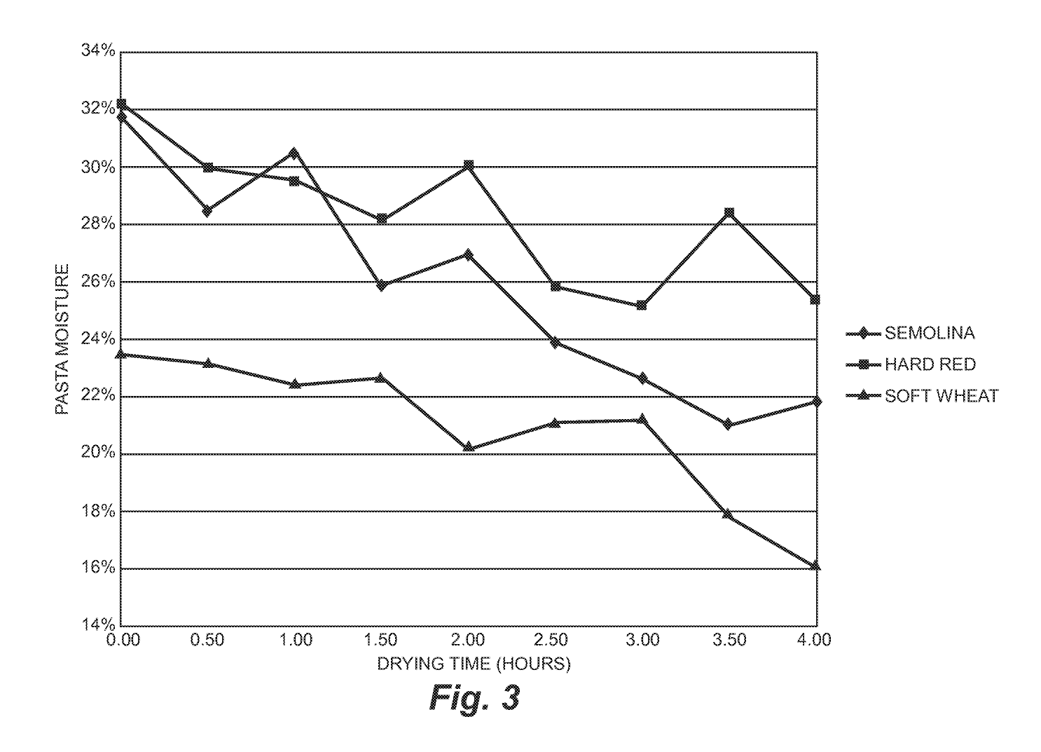

FIG. 3 is a plot of the drying data for the three samples. The X-axis of the plot is time while the Y-axis of the plot is weight percent moisture in the samples. The data show that the extruded pasta product formed from low protein soft white wheat flour combined with 20 weight percent water dried to a product moisture of 16 weight percent within approximately 4 hours, faster than either of the other two samples.

### Example 3

### Cook Time

Three different pasta samples were prepared to evaluate how the temperature of the water used to form the extrudable pasta dough impacts the cooking time of the resultant dried pasta product. A first sample was prepared by mixing soft wheat flour with 20 weight percent water at 60 degrees Celsius and 2 weight percent steam. A second sample was prepared by mixing soft wheat flour with 25 weight percent water at 90 degrees Celsius and no steam. A third sample was prepared by mixing soft wheat flour with 16 weight percent water at 70 degrees Celsius and 6 weight percent steam. The weight percentages of water/steam added for each of the three samples was based on the weight of the soft wheat flour.

For all three samples, the water/steam and flour ingredients were homogenously mixed together until the flour was fully hydrated to achieve a dough. All three samples were then extruded using the same extruder configuration and same extrusion conditions. In particular, all samples were extruded using a Buhler Plymatik extruder. The samples were hot extruded by heating the extruder jacket with circulating 65 degree Celsius water. The dough for each the samples was extruded into elbow-shaped pasta pieces. The extruded elbow-shaped pasta pieces were then dried in a controlled humidity dryer at 60 degrees Celsius and 80% relative humidity for the first five minutes, 88 degrees Celsius and 80% relative humidity for the next forty five minutes, and 85 degrees Celsius and 77% relative humidity for the final ninety five minutes.

For comparison purposes, two pasta samples were prepared using comparatively cold water to form the extrudable pasta dough. A first comparative sample was prepared by mixing semolina flour with 30 weight percent water at tap temperature (approximately 21 degrees Celsius) and no steam. A second comparative sample was prepared by mixing hard red spring wheat flour with 30 weight percent water at tap temperature (approximately 21 degrees Celsius) and no steam. The constituent ingredients of the comparative samples were homogenously mixed to form an extrudable dough and then extruded using the same extruder configuration and same extrusion conditions. The comparative samples were extruded using the same Buhler Plymatik extruder discussed above. The comparative samples were cold extruded by cooling the extruder jacket with cold circulating water to maintain a dough exit temperature ranging from 45 degrees Celsius to 50 degrees Celsius. The dough for each the samples was extruded into elbow-shaped pasta pieces. The extruded elbow-shaped pasta pieces were then dried in a controlled humidity dryer at 60 degrees Celsius and 80% relative humidity for the first five minutes, 88 degrees Celsius and 80% relative humidity for the next forty five minutes, and 85 degrees Celsius and 77% relative humidity for the next one hundred and sixty five minutes.

Cook times for the three samples and two comparative samples were evaluated qualitatively. For example sample and comparatively sample, pieces of dried pasta were placed in a pot of boiling water to cook. Pasta pieces were extracted at periodic intervals and qualitatively evaluated to determine when the pasta was deemed cooked. Qualitative evaluation included visual inspection of the pasta, evaluation of the compressibility and feel of the pasta in the hand of the evaluator, and evaluation of the texture and rigidity in the mouth of the evaluator. The pasta was deemed cooked when the pasta appeared to have an al dente textural firmness. The cook time was recorded as the elapsed time from when a pasta was first placed in the boiling water until the time when the pasta was extracted from the boiling water and determined to have al dente textural firmness. The following table summarizes the pasta preparation parameters and corresponding cook times.

| | | | | Comparative | Comparative |
|---|---|---|---|---|---|
| | Sample 1 | Sample 2 | Sample 3 | Sample 1 | Sample 2 |
| Flour | Soft Wheat | Soft Wheat | Soft Wheat | Semolina | Hard Red |
| | | | | | Spring Wheat |
| Water Amount | 20/2 | 25/0 | 16/6 | 30/0 | 30/0 |
| (wt %)/Steam | | | | | |
| Amount (wt %) | | | | | |
| Water | 60 | 90 | 70 | 21 | 21 |
| Temperature | | | | | |
| (deg. Celsius) | | | | | |
| Extruder | 65 | 65 | 65 | Cooled to | Cooled to |
| Cylinder | | | | provide a | provide a |
| Temperature | | | | dough exit | dough exit |
| (deg. Celsius) | | | | temperature | temperature |
| | | | | 45-50 | 45-50 |
| Drying Time | 135 | 145 | 145 | 215 | 215 |
| (minutes) | | | | | |
| Cook Time | 8.5 | 4.5 to 5 | 9 | 8 | 8 |
| (minutes) | | | | | |

The results showed that the pasta produced using an extrudable dough formed with hot liquid water cooked substantially faster than pasta produced using extrudable dough formed using either steam or comparatively cold liquid water.

1. A method comprising:
blending a flour containing ungelatinized starch and less than 11 weight percent protein with liquid water to form an extrudable pasta dough, the liquid water having a temperature greater than 50 degrees Celsius such that blending the flour with the liquid water initiates gelatinization of the ungelatinized starch, wherein a ratio of the temperature of extrusion divided by the temperature of the liquid water ranges from 0.7 to 1.3;
extruding the extrudable pasta dough at a temperature greater than 50 degrees Celsius and thereby further partially gelatinizing the ungelatinized starch to produce an extruded pasta product; and
drying the extruded pasta product.

2. The method of claim 1, wherein the flour contains from 71% to 75% ungelatinized starch.

3. The method of claim 1, wherein the liquid water has a temperature ranging from 60 degrees Celsius to 95 degrees Celsius, extruding the extrudable pasta dough at a temperature greater than 50 degrees Celsius comprises extruding the extrudable pasta dough at temperature ranging from plus 15 degrees Celsius to minus 15 degrees Celsius of the temperature of the liquid water, and drying the extruded pasta product comprises drying the extruded pasta product to less than 13 weight percent moisture.

4. A method comprising:
blending a flour containing ungelatinized starch and less than 11 weight percent protein with liquid water to form an extrudable pasta dough, the liquid water having a temperature greater than 50 degrees Celsius such that blending the flour with the liquid water initiates gelatinization of the ungelatinized starch;
extruding the extrudable pasta dough at a temperature greater than 50 degrees Celsius and thereby further partially gelatinizing the ungelatinized starch to produce an extruded pasta product; and
drying the extruded pasta product to produce a dried pasta product exhibiting a cook time in boiling water of less than 6 minutes.

5. The method of claim 4, wherein the flour contains from 71% to 75% ungelatinized starch.

6. The method of claim 4, wherein the liquid water has a temperature ranging from 60 degrees Celsius to 95 degrees Celsius, extruding the extrudable pasta dough at a temperature greater than 50 degrees Celsius comprises extruding the extrudable pasta dough at temperature ranging from plus 15 degrees Celsius to minus 15 degrees Celsius of the temperature of the liquid water, and drying the extruded pasta product comprises drying the extruded pasta product to less than 13 weight percent moisture.

7. A method comprising:
blending a flour containing ungelatinized starch and less than 11 weight percent protein with liquid water having a temperature ranging from 60 degrees Celsius to 98 degrees Celsius in an absence of steam to form an extrudable pasta dough,
hot extruding the extrudable pasta dough at a temperature greater than 50 degrees Celsius without exposing the extrudable pasta dough to steam to produce an extruded pasta product; and
drying the extruded pasta product.

8. The method of claim 7, wherein a ratio of the temperature of extrusion divided by the temperature of the liquid water ranges from 0.7 to 1.3.

9. The method of claim 7, wherein the extruded pasta product has from 30% starch gelatinization to 80% starch gelatinization.

10. The method of claim 7, wherein blending the flour with liquid water to form the extrudable pasta dough comprises forming an extrudable pasta dough having a moisture content less than 30 weight percent, and drying the extruded pasta product comprises drying the extruded pasta product to less than 12 weight percent moisture.

11. The method of 7, wherein hot extruding the extrudable pasta dough at a temperature greater than 50 degrees Celsius comprises extruding the extrudable pasta dough at a temperature greater than 65 degrees Celsius.
